(19) United States
(12) Patent Application Publication
(10) Pub. No.: US 2022/0031057 A1
(43) Pub. Date: Feb. 3, 2022

(54) A CONTAINER FOR A TOOL AND A TOOL WITH SUCH A CONTAINER

(71) Applicant: SCRUBBIS AB, Vallingby (SE)

(72) Inventor: Yosef HASSAN, Vallingby (SE)

(21) Appl. No.: 17/280,194

(22) PCT Filed: Oct. 30, 2019
(86) PCT No.: PCT/SE2019/000016

§ 371 Date: Mar. 26, 2021

(30) Foreign Application Priority Data
Sep. 26, 2018 (SE) 1800179-2

(51) Int. Cl. A46B 11/00; A46B 15/00

(52) U.S. Cl. CPC A46B 11/0062; B08B 1/002; A46B 2200/302; A46B 15/0095

(57) ABSTRACT

The invention relates to a container for a tool with a tool head. The tool head has conduits conducting liquid extending through the tool head. The container is attachable to the tool head. In use, the container is filled with liquid. The container comprises a tubular diaphragm held extended by at least one spacer element. The tubular diaphragm is in use at its lower end air tightly attached to the tool head. The membrane is easily compacted into an element that takes up a small storage volume, but is still able to remain outstretched into a container due to the spacer element, even when subjected to external fluid pressure.

The spacer element comprises filler openings. The tool has a shaft and the spacer element has a tool connection surrounding the tool shaft. In this manner, the container is guided up and down the shaft as the container is erected and contracted.

The present invention relates to a container for a tool and a tool with such a container according to the introductory portions of the independent claims.

### BACKGROUND OF THE INVENTION

US2018020818 discloses a brush with a brush head, where liquid from a container on the brush shaft flows down to and out through the brush head. The container is adapted for a particular brush model and the brush with the container occupies a larger storage volume than the brush itself would do.

EP1510164 discloses another type of brush with a brush head, where liquid from a container on the brush shaft flows down to and out through the brush head. The container forms an integral part of a particular brush model and although the container is somewhat compressible, the brush with the container takes up a larger storage volume than the brush itself would do.

An object of the invention is therefore to provide a container for a tool and a tool with such a container requiring less storage volume than similar prior art embodiments do.

These and other objects are attained by a container for a tool and a tool with such a container according to the characterising portions of the independent claims.

### SUMMARY OF THE INVENTION

The invention relates to a container 1-2 for a tool 3-4, 4b with a tool head 3. The tool head 3 is provided with conduits 7 conducting liquid that extend through the tool head 3. The container is attachable to the tool head. In use, the container is filled with liquid. The container 1-2 comprises a tubular diaphragm 2 which is held extended by at least one spacer element 1, 1a-b. The tubular diaphragm 2 is in use at its lower end air tightly attached to the tool head. The membrane can advantageously easily be compacted into an element that takes up a small storage volume, but is still able to remain outstretched into a container due to the spacer element, even when it is subjected to external fluid pressure.

The spacer element 1,1a-b preferably comprises at least one filler opening 5a-b.

Typically, the tool 3-4, 4b comprises or is attachable to a tool shaft 4, 4b and in an advantageous embodiment of the invention, the at least one spacer element 1, 1a-b comprises at least one tool connection 8 arranged to surround the tool shaft 4. In this manner, the container 1-2 is guided up and down the shaft as the container is erected and contracted.

In yet another advantageous embodiment of the invention, the container 1-2 comprises more than one spacer element 1, 1a-b.

The invention further relates to a tool 3-4, 4b with a tool head 3 conducting liquid, which is connected to such a container 1-2.

### BRIEF DESCRIPTION OF THE DRAWINGS

FIG. 1 shows a first embodiment of the invention in an extended state

FIG. 2 shows the first embodiment of the invention in a compressed state

FIG. 3 shows the brush head in greater detail

FIG. 4 shows the brush head in greater detail with conduits

FIG. 5 shows a second embodiment of the invention in the extended unloaded state

FIG. 6 shows the second embodiment of the invention in the extended state under the influence of external pressure

FIG. 7 shows a third embodiment of the invention in a disassembled state

FIG. 8 shows the third embodiment of the invention in an assembled state

### DESCRIPTION OF PREFERRED EMBODIMENTS

The invention relates to a container for a brush or other cleaning device. The container may be folded out to a state where it can be filled with liquid and can be folded into a state for storage.

The container consists of a membrane 2, typically made from plastic, which is illustrated in the figures as if it was transparent, to illustrate the embodiment more clearly. The diaphragm 2 is kept extended by a spacer element 1, which prevent the diaphragm from collapsing if exposed to external pressure, which means that the container can be immersed in water and still remain extended. Immersed in water, the water fills the interior of the container as soon as the liquid level reaches the top of the container and the water can then be used for cleaning.

The container is connected at its lower end to a brush head 3 with conduits permitting the water to slowly flow out of the container through the brush head. Apart from the conduits through the brush head, the container membrane is air tightly connected to the brush head so that the water does not leak out in an uncontrolled manner. The container may be firmly and airtightly connected to the brush head, so that the brush with the container constitutes a solid element or the container may be detachable. Details of construction are described below in connection with the embodiments presented.

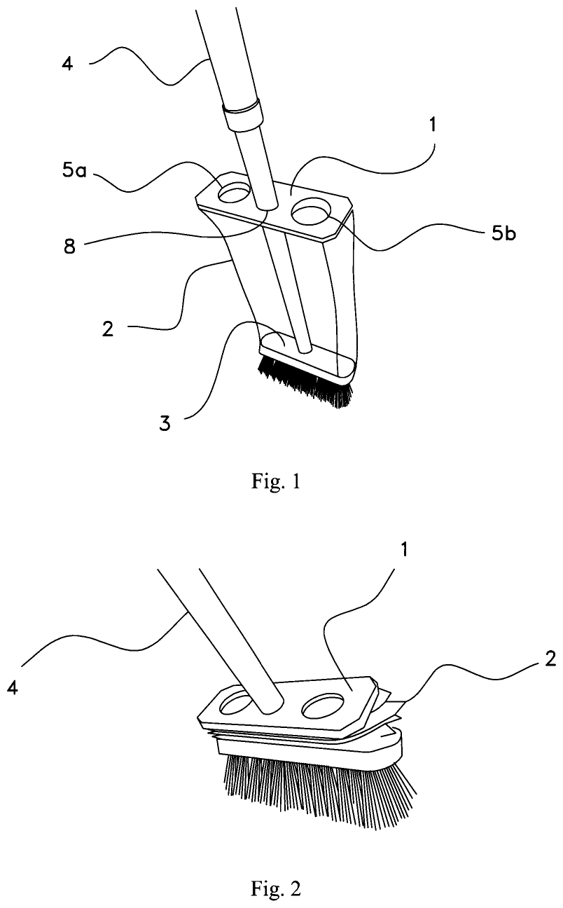

FIG. 1 shows a first embodiment of the invention in an extended state, that is, in a position for use, where the container may be filled with water. The container is constituted by a diaphragm 2 in the form of a tube which extends along the brush handle 4 and surrounds the handle. The diaphragm extends from the brush head 3 up to an upper end where a spacer element 1 holds the diaphragm extended. In this embodiment, the diaphragm is extended at two levels, both around the brush head and at its upper end where the spacer element 1 is arranged.

The spacer element 1 is embodied as a disc with three openings 5a-b, 8. The spacer element 1 has a centrally located brush handle opening 8 surrounding the brush handle. The brush handle opening 8 allows the spacer element 1 to slide up or down along the brush handle, so that the container can be changed from an extended to a compressed state, but also holds the unloaded spacer element 1 in a desired position. In the figure, the spacer element 1 is arranged in its uppermost position and thus holds the container in a fully extended state to receive a maximum amount of water, but generally the brush handle opening 8 can secure the spacer element 1 in any desired position on the brush handle depending on the volume of water the container should receive.

The spacer element is also provided with two filling openings 5a-b, symmetrically positioned on each side of the brush shaft. If the container is immersed in water, the water flows into the interior of the container via these filling openings 5a-b.

FIG. 2 shows the first embodiment of the invention in a compressed state, where the spacer element 1 has been pushed down along the brush shaft as close to the brush head as possible. The membrane of the container 2 is folded and compressed between the spacer element 1 and the upper side of the brush head. The container now occupies a minimal volume which is advantageous when the brush is to be stored when not in use.

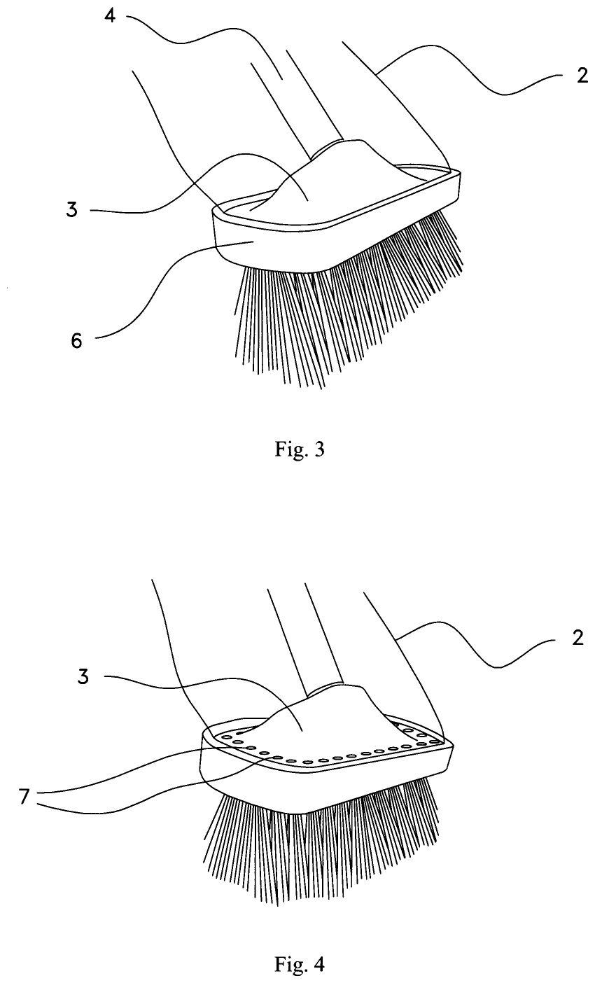

FIG. 3 shows the brush head in greater detail and here only the lower part of the brush shaft 4 and the membrane 2 is illustrated. at this lower end of the container the membrane encloses the brush head and is held in this position by a fastener 6 embodied as an annular detail extending around the circumference of the brush head. The fastener 6 may be a rigid member shaped to fit around the brush head with the diaphragm arranged inside the fastener 6, where the fastener is screwed onto the brush head. Alternatively, the fastener 6 may be formed as of an elastic ring which is threaded around the brush head and is retained by being tensioned as it is applied. Since the water in the container is intended to flow through the brush head, the seal between the diaphragm and the brush head is not of great importance, as long as any leaks are small and the main function of the fastener 6 is to keep the diaphragm in position. Obviously, the membrane can be sealed to the brush head in other ways, such as with, for example, gluing.

FIG. 4 shows the brush head in greater detail with conduits 7 in the brush head which allow the water in the container's interior to slowly leak through the brush head. The conduits extend through the brush head from its upper side to its underside and the conduits are arranged along the outer edge of the brush head, inside the fastener element 6. Obviously, the conduits may be positioned differently and also be replaced by some element which slowly permits liquid though, such as a sponge or the like.

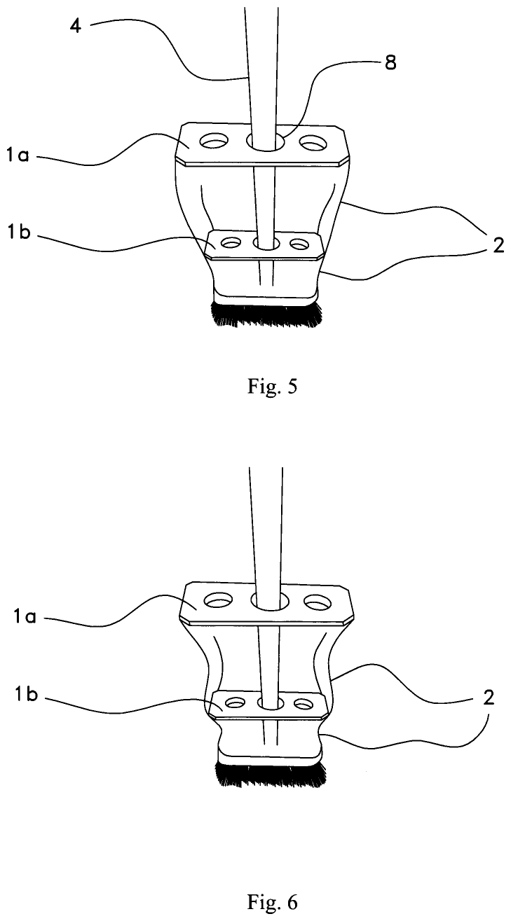

FIG. 5 shows a second embodiment of the invention in the extended unloaded state. The second embodiment, in the same way as the first embodiment, has a brush head with a shaft 4 and a diaphragm 2 which forms a tube attached to the brush head. Unlike the first embodiment, the diaphragm 2 is held extended by two instead of one spacer element 1a-b. The upper spacer element 1a is arranged at the upper end of the membrane and the lower spacer element 1b is arranged at the centre of the membrane. The diaphragm is thus held extended on three levels, first around the brush head and secondly at its upper end and in the middle where the spacers 1a-b are arranged.

The spacers 1a-b are embodied in the same way as the first embodiment as discs with three openings. The spacers 1a-b have a centrally located brush handle opening 8 surrounding the brush handle. The spacers are also provided with filling openings 5a-b, symmetrically located on each side of the brush shaft. If the container is immersed in water, the water first enters the interior of the container via filling openings 5a-b in the upper spacer element 1a and then proceeds down into the container via filling openings 5a-b in the lower spacer element 1b.

FIG. 6 shows the second embodiment of the invention in the extended state under the influence of external pressure. The figure clearly illustrates how the diaphragm bulges inwardly between the spacers 1a-b, but because there are two spacers, it bulges less than it would have done with only one spacer. Obviously, the construction can advantageously comprise any number of spacers. With more spacer elements, the liquid in the container is also better stabilized and allowed to less to splash around, so the risk of the liquid being thrown out of the container is reduced even if it swings or when the brush is moved back and forth during brushing.

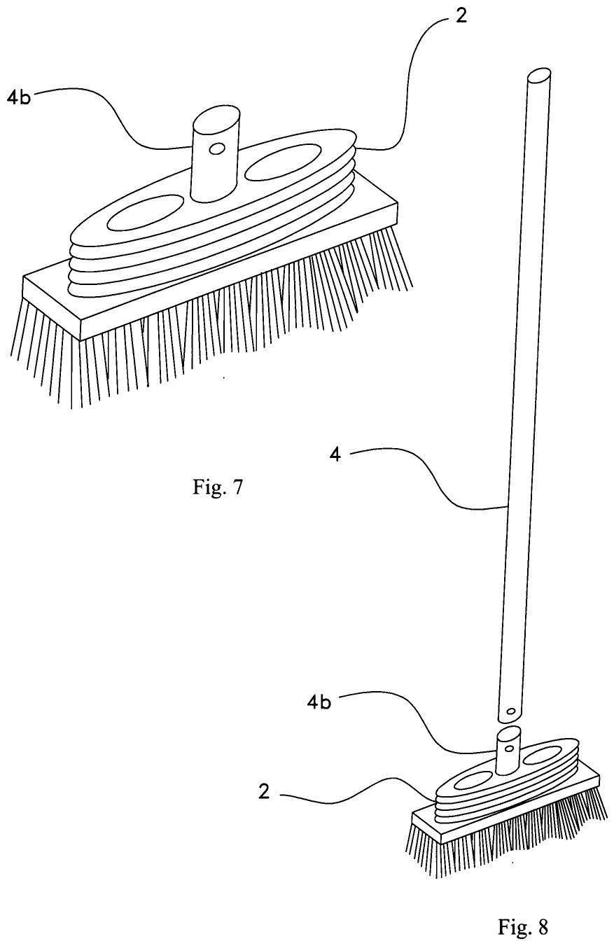

FIG. 7 shows a third embodiment of the invention in a disassembled state. The third embodiment is intended for a brush head with a shaft receiving element 4b to which a brush shaft can be secured. A container 2 is mounted on the brush head, which in the figure is compressed so that it occupies the smallest possible space. The container 2, just as in the first and second embodiments, consists of a membrane and is held extended by spacer elements. The spacers in the third embodiment are elliptical and cover a surface slightly smaller than the top of the brush head. The spacer elements are in this embodiment too, provided with filling openings and a brush handle opening, but the brush handle opening here surrounds the shaft receiving element 4b in which the brush shaft can be attached.

FIG. 8 shows the third embodiment of the invention in an assembled state and here the brush shaft 4 is attached to the shaft receiving element 4b. The brush shaft 4 and the shaft receiving element 4b now jointly form the shaft of the brush and the brush handle opening can now be slid up along it to increase the volume of the container. By the third embodiment allowd the brush shaft 4 to be removed from the brush head and the container can be compressed, the entire device can be stored in a very space efficient manner.

The brush with the container is, for example, intended to be used for cleaning boat decks, where water in the container is used to rinse away dirt that is released with the brush. Obviously, the container can be filled with other liquids, such as water with detergent, paint, oil or something else. The brush head itself constitutes an example of how the container may be used, and the brush head can be replaced with a mop head, a scraper or any other tool. Regardless of what type of tool the container is used with, the effect remains that liquid from the interior of the container is dosed out around the tool head.

In the described embodiments, the spacer elements comprise a brush handle opening 8 surrounding the brush handle, but this can be replaced by differently designed connections between the spacer elements and the brush handle. The connections do not need to fully enclose the brush handle but merely grip it so that the spacer elements are supported by it and can thus, for example, consist of a u-shaped opening extending from the edge of the spacer element. In this way, the container can be pushed onto the brush handle from the side rather than being threaded on along the longitudinal extent of the brush handle, which can be advantageous if, for example, the brush handle has a larger diameter portion than the rest of the brush handle, as the brush handle has in the illustrated embodiments.

In the described embodiments, the spacer elements comprise two symmetrically positioned filler openings 5a-b, but obviously there may be fewer or more filler openings and these may be differently positioned. They may also be covered by nets or permeable foam rubber to prevent debris from entering the interior of the container.

1. A container (1-2) for a tool (3-4, 4b) with a tool head (3), where conduits (7) conduct liquid extend through the tool head (3), where the container is attachable to the tool head, and where in use the container is filled with liquid, characterised in that the container (1-2) comprises a tubular diaphragm (2) which is held extended by at least one spacer element (1, 1a-b), and where the tubular diaphragm (2) at its lower end in use is air tightly attached to the tool head.

2. A container (1-2) according to claim 1, characterised in that the at least one spacer element (1, 1a-b) comprises at least one filler opening (5a-b).

3. A container (1-2) according to claim 1, characterised in that the tool (3-4, 4b) comprises a tool shaft (4, 4b) and the at least one spacer element (1, 1a-b) comprises at least one tool connection (8) arranged to surround the tool shaft (4).

4. A container (1-2) according to claim 1, characterised in that the container (1-2) comprises more than one spacer element (1, 1a-b).

5. A tool (3-4, 4b) with a tool head (3), where conduits (7) passing through liquid extend through the implement head (3), where the tool comprises a container (1-2) attached to the tool head, and where in use, the container is filled with liquid, characterised in that the container (1-2) comprises a tubular diaphragm (2) which is held out by at least one spacer (1, 1a-b)), and where the tubular diaphragm (2) at its bottom is airtightly connected to the tool head.

6. A tool (3-4, 4b) according to claim 5, characterised in that the at least one spacer element (1, 1a-b) comprises at least one filler opening (5a-b).

7. A tool (3-4, 4b) according to claim 6, characterised in that the tool (3-4, 4b) comprises a tool shaft (4, 4b) and the at least one spacer element (1, 1a-b) comprises at least one tool connection (8) arranged to surround the tool shaft (4).

8. A tool (3-4, 4b) according to claim 5, characterised in that the container (1-2) comprises more than one spacer element (1, 1a-b).
